(19) United States
(12) Patent Application Publication
(10) Pub. No.: US 2013/0020973 A1
(43) Pub. Date: Jan. 24, 2013

(54) MOTOR DRIVING CIRCUIT AND MOTOR DRIVING SYSTEM

(71) Applicant: Toshiaki OHGUSHI, Yokohama-shi (JP)

(72) Inventor: Toshiaki OHGUSHI, Yokohama-shi (JP)

(73) Assignee: KABUSHIKI KAISHA TOSHIBA, Tokyo (JP)

(21) Appl. No.: 13/369,668

(22) Filed: Feb. 9, 2012

(30) Foreign Application Priority Data
Jul. 19, 2011 (JP) 2011-158068

(51) Int. Cl. H02P 23/00; H02P 6/10

(52) U.S. Cl. 318/400.23; 318/494; 318/473

(57) ABSTRACT

A motor driving circuit controls driving of a motor based on communications with an external MCU. The motor driving circuit has a first port that receives a first digital signal outputted from the MCU. The motor driving circuit has a duty measuring circuit that measures a duty of the first digital signal inputted through the first port and outputs a duty information signal corresponding to the measured duty. The motor driving circuit has a frequency measuring circuit that measures a frequency of the first digital signal and outputs a frequency information signal corresponding to the measured frequency of the first digital signal.

### CROSS-REFERENCE TO RELATED APPLICATION

This application is based upon and claims the benefit of priority from the prior Japanese Patent Application No. 2011-158068, filed on Jul. 19, 2011, the entire contents of which are incorporated herein by reference.

### BACKGROUND

1. Field

Embodiments described herein relate generally to a motor driving circuit and a motor driving system.

2. Background Art

Conventionally, a motor driving system for driving a motor includes a motor driving circuit, a micro control unit (MCU), and a motor driver.

Typically, a motor driving circuit inputs the rotation speed of a motor to an MCU.

Some applications utilizing such a motor driving system may require adjustments to a PWM frequency, a dead time, a lead angle, a pattern of motor driving waveform, control timing, and so on.

Unfortunately, communications between a motor driving circuit and an MCU are limited by the number of ports (e.g., one) allocated for motor driving control. The variety of transmittable information is also limited.

### BRIEF DESCRIPTION OF THE DRAWINGS

FIG. 1 is a diagram showing an example of the configuration of a motor driving system 1000 according to a first embodiment;

FIG. 2 is a diagram showing an example of the configuration of a motor driving system 2000 according to the second embodiment;

FIGS. 3A and 3B are diagrams showing examples of the configuration of a motor driving system 3000 according to the third embodiment;

FIG. 4 is a diagram showing an example of the relationship between the current amplitude and lead angle of a motor M;

FIG. 5 is a diagram showing an example of the configuration of a motor driving system 4000 according to the fourth embodiment;

FIG. 6 is a diagram showing an example of the relationship between a frequency of the first digital signal (Tsp signal) and a selected motor parameter;

FIG. 7 is a diagram showing an example of the configuration of a motor driving system 5000 according to the fifth embodiment;

FIG. 8 is a diagram showing an example of the relationship between a resonance level of the motor M and a PWM frequency;

FIG. 9 is a diagram showing an example of the configuration of a motor driving system 6000 according to a sixth embodiment;

FIG. 10 is a diagram showing an example of the configuration of a motor driving system 7000 according to the seventh embodiment;

FIG. 11 is a diagram showing an example of the relationship between the frequency of the first digital signal (Tsp signal) and the control parameters to be selected;

FIG. 12 is a diagram showing an example of the configuration of a motor driving system 8000 according to the eighth embodiment;

FIG. 13 is a diagram showing an example of the configuration of a motor driving system 9000 according to the ninth embodiment;

FIG. 14 is a diagram showing an example of the relationship between a frequency of the first digital signal (Tsp signal) and the motor information to be selected;

FIG. 15 is a diagram showing an example of the configuration of a motor driving system 10000 according to the tenth embodiment; and

FIG. 16 is a waveform chart showing an example of the waveforms of the first digital signal (Tsp signal), a measured frequency, a measured duty, the update flag signal, and a rotation speed command value.

### DETAILED DESCRIPTION

A motor driving circuit according to an embodiment controls driving of a motor based on communications with an external MCU. The motor driving circuit has a first port that receives a first digital signal outputted from the MCU. The motor driving circuit has a duty measuring circuit that measures a duty of the first digital signal inputted through the first port and outputs a duty information signal corresponding to the measured duty. The motor driving circuit has a frequency measuring circuit that measures a frequency of the first digital signal and outputs a frequency information signal corresponding to the measured frequency of the first digital signal.

Embodiments will be described below with reference to the accompanying drawings. In the following embodiments, the present invention is applied to the control of a three-phase motor whose rotation speed is controlled by a three-phase driving voltage.

The present invention is similarly applicable to other kinds of motors whose rotation speeds are controlled by driving voltages.

### First Embodiment

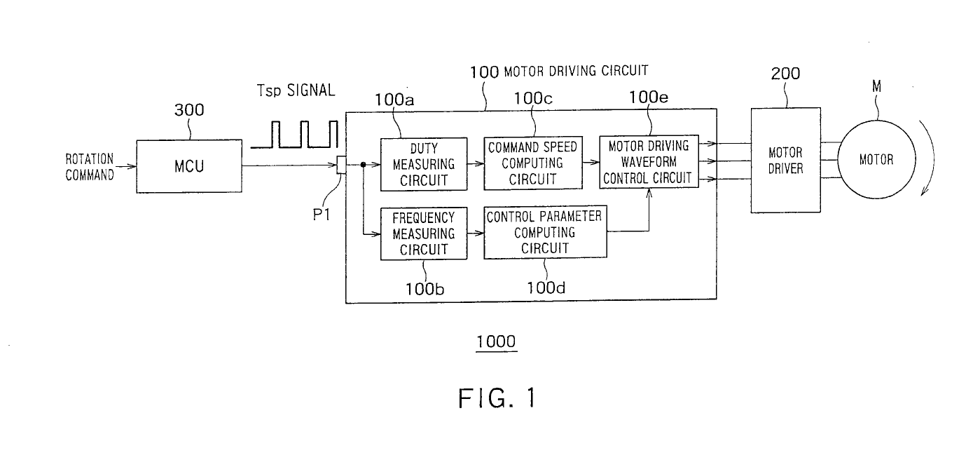

FIG. 1 illustrates an example of the configuration of a motor driving system 1000 according to a first embodiment.

As illustrated in FIG. 1, the motor driving system 1000 includes a motor driving circuit 100, a motor driver 200, an MCU 300, and a motor M.

The motor driving system 1000 is applied for, for example, driving fans and compressors used for products such as air conditioners and refrigerators.

The MCU 300 controls the overall operations of products such as air conditioners and refrigerators and controls the driving of fans and compressors in response to a rotation command. In the present embodiment, one of the limited ports of the MCU 300 is allocated to the motor driving circuit 100.

The motor M in the present embodiment is a three-phase motor. The motor M is driven by a three-phase driving voltage that produces current flowing through a three-phase coil. As described above, the motor M may be another kind of motor whose rotation speed is controlled by a driving voltage.

The motor driver 200 supplies the three-phase driving voltage as a power supply voltage to the motor M in response to a driving control signal outputted from the motor driving circuit 100. The motor driving circuit 100 controls the motor driver 200 (controls the three-phase driving voltage (or driving current) to the motor M) by the driving control signal according to communications with the external MCU 300, so that the driving of the motor M is controlled.

As illustrated in FIG. 1, the motor driving circuit 100 includes a first port P1, a duty measuring circuit 100a, a frequency measuring circuit 100b, a command speed computing circuit 100c, a control parameter computing circuit 100d, and a motor driving waveform control circuit 100e.

The first port P1 is fed with a first digital signal (e.g., a Tsp signal) outputted from the MCU 300 in response to a rotation command.

The duty measuring circuit 100a measures the duty of the first digital signal inputted through the first port P1 and outputs a duty information signal corresponding to the measured duty.

The frequency measuring circuit 100b measures the frequency of the first digital signal and outputs a frequency information signal corresponding to the measured frequency of the first digital signal.

The command speed computing circuit 100c computes, based on the duty information signal, the rotation speed of the motor M commanded by the MCU 300 and outputs a rotation speed information signal containing information on the computed rotation speed.

The control parameter computing circuit 100d computes, based on the frequency information signal, a control parameter for adjusting the driving control of the motor M commanded by the MCU 300 and outputs a control parameter information signal containing information on the computed control parameter.

The motor driving waveform control circuit 100e generates the driving control signal as a PWM signal for driving the motor M at the commanded rotation speed, based on the rotation speed information signal and the control parameter information signal.

In this configuration, the control parameter is, for example, one of the PWM frequency of the driving control signal, the dead time of the driving control signal, the pattern of motor driving waveform of the driving control signal, the control timing of the driving control signal (e.g., a DC excitation time for fixing a rotor at a predetermined position), a current controller gain for passing a desired current through the motor M or a speed controller gain for rotations at a desired rotation speed (a current controller and a speed controller are both disposed in a motor driving waveform control unit but are not shown in FIG. 1), and the lead angle of the driving control signal.

As described above, the motor driving waveform control circuit 100e generates the driving control signal based on the rotation speed information signal so as to drive the motor M at the commanded rotation speed. Moreover, the motor driving waveform control circuit 100e controls the PWM frequency, the dead time, or the control timing of the driving control signal based on the control parameter and controls the current controller gain for passing the desired current through the motor M or the speed controller gain for rotations at the desired rotation speed (the current controller and the speed controller are both disposed in the motor driving waveform control unit but are not shown in FIG. 1) or the lead angle of the driving control signal.

In other words, the motor driving circuit 100 generates the driving control signal as a PWM signal for driving the motor M at the commanded rotation speed, based on an rotation speed obtained based on the duty of the first digital signal outputted from the MCU 300 and information (control parameter) obtained based on the frequency of the first digital signal.

As described above, the motor driving circuit 100 according to the first embodiment can increase the variety of information transmitted through the limited number of ports of the MCU 300.

Furthermore, the number of wires of the MCU 300 and the motor driving circuit 100 can be reduced.

Moreover, the number of terminals (ports) can be reduced, thereby reducing the size and cost of a package.

The frequency of the first digital signal may be correlated with a motor parameter (a winding resistance, a reactance, and an induced voltage) set for the motor control circuit 100, instead of the control parameter.

### Second Embodiment

In the first embodiment, the duty of the first digital signal and the rotation speed of the motor M are correlated with each other while the frequency of the first digital signal and the control parameter are correlated with each other.

Specifically, in the first embodiment, the command speed computing circuit 100c computes, based on the duty information signal, the rotation speed of the motor M commanded by the MCU 300, and the control parameter computing circuit 100d computes, based on the frequency information signal, the control parameter for adjusting the driving control of the motor M commanded by the MCU 300.

Even if the correlation is reversed, the variety of motor information transmitted through the limited number of ports of the MCU 300 can be increased.

In a second embodiment, the frequency of a first digital signal and the rotation speed of a motor M are correlated with each other while the duty of the first digital signal and a control parameter are correlated with each other.

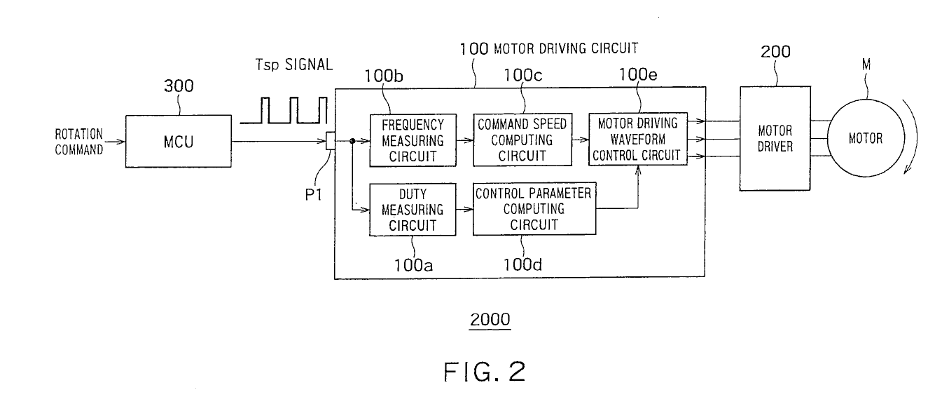

FIG. 2 illustrates an example of the configuration of a motor driving system 2000 according to the second embodiment. In FIG. 2, the same reference numerals as in FIG. 1 indicate the same configurations as in the first embodiment unless otherwise explained.

As illustrated in FIG. 2, the motor driving system 2000 includes a motor driving circuit 100, a motor driver 200, an MCU 300, and the motor M as in the first embodiment.

In this configuration, the motor driving circuit 100 includes a first port P1, a duty measuring circuit 100a, a frequency measuring circuit 100b, a command speed computing circuit 100c, a control parameter computing circuit 100d, and a motor driving waveform control circuit 100e as in the first embodiment.

In the second embodiment, the command speed computing circuit 100c computes, based on a frequency information signal, the rotation speed of the motor M commanded by the MCU 300 and outputs a rotation speed information signal containing information on the computed rotation speed as in the first embodiment.

Moreover, in the second embodiment, the control parameter computing circuit 100d computes, based on a duty information signal, a control parameter for adjusting the driving control of the motor M commanded by the MCU 300 and outputs a control parameter information signal containing information on the computed control parameter.

The motor driving waveform control circuit 100e generates a driving control signal as a PWM signal for driving the motor M at a commanded rotation speed, based on the rotation speed information signal and the control parameter information signal as in the first embodiment.

As in the first embodiment, the motor driving waveform control circuit 100e generates the driving control signal based on the rotation speed information signal so as to drive the motor M at the commanded rotation speed, controls the PWM frequency, dead time, or control timing of the driving control signal based on the control parameter, and controls a current controller gain for passing a desired current through the motor M, a speed controller gain for rotations at a desired rotation speed (a current controller and a speed controller are both disposed in a motor driving waveform control unit but are not shown in FIG. 2), or the lead angle of the driving control signal.

In other words, the motor driving circuit 100 generates the driving control signal as a PWM signal for driving the motor M at the commanded rotation speed, based on an rotation speed obtained according to the frequency of the first digital signal outputted from the MCU and information (control parameter) obtained based on the duty of the first digital signal.

Other configurations of the motor driving circuit 100 are identical to those of the first embodiment.

As described above, the motor driving circuit 100 of the second embodiment can increase the variety of information transmitted through the limited number of ports of the MCU 300 as in the first embodiment.

Furthermore, the number of wires of the MCU 300 and the motor driving circuit 100 can be reduced.

Moreover, the number of terminals (ports) can be reduced, thereby reducing the size and cost of a package.

As has been discussed, in the second embodiment, the frequency of the first digital signal and the rotation speed of the motor M are correlated with each other while the duty of the first digital signal and the control parameter are correlated with each other. The correlation may be reversed in the following embodiments.

### Third Embodiment

A third embodiment will describe an example of the configuration of an MCU for setting the duty and frequency of a first digital signal (a lead angle is selected as a control parameter).

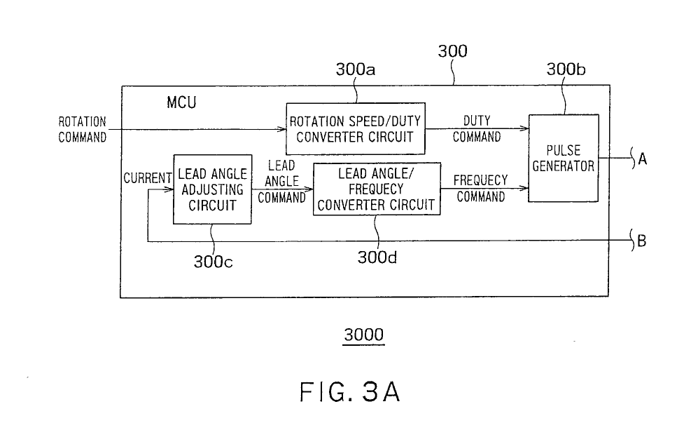

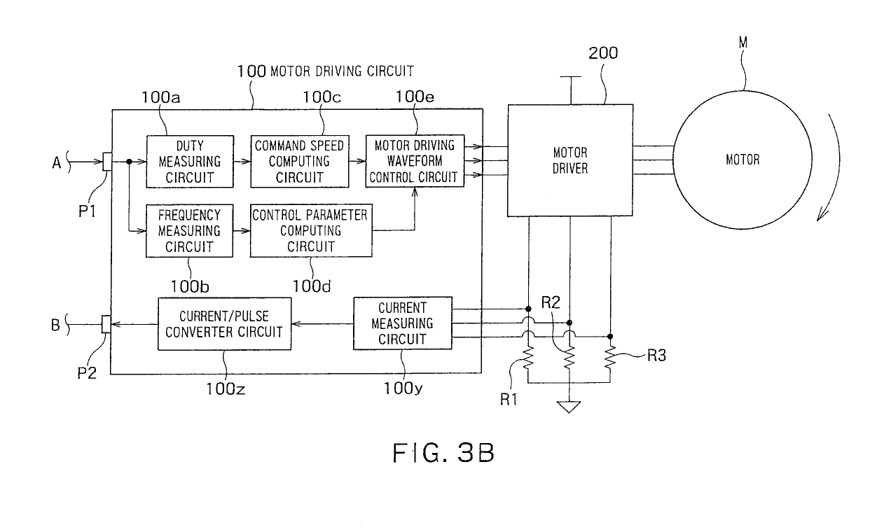

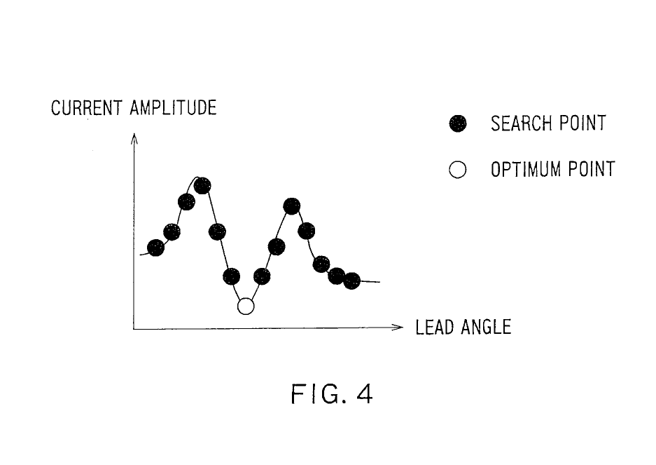

FIG. 3 illustrates an example of the configuration of a motor driving system 3000 according to the third embodiment. FIG. 4 shows an example of the relationship between the current amplitude and lead angle of a motor M. In FIG. 3, the same reference numerals as in FIG. 1 indicate the same configurations as in the first embodiment unless otherwise explained.

FIGS. 3A and 3B constituting FIG. 3 are connected to each other at reference numerals A and B.

As illustrated in FIG. 3, the motor driving system 3000 includes a motor driving circuit 100, a motor driver 200, an MCU 300, and the motor M as in the first embodiment.

The motor driving circuit 100 further includes a current measuring circuit 100y and a current/pulse converter circuit 100z in addition to the configuration of the first embodiment.

The current measuring circuit 100y measures the driving current of the motor driver 200 and outputs a measure signal corresponding to the measure result.

The current/pulse converter circuit 100z outputs the measure signal as a pulse signal. The measure signal may be modulated to a frequency, a duty or communication interfaces such as I2C, UART, and SPI.

As in the first embodiment, the MCU 300 controls the overall operations of products such as air conditioners and refrigerators and controls the driving of fans and compressors in response to a rotation command.

As illustrated in FIG. 3, the MCU 300 includes, for example, a rotation speed/duty converter circuit 300a, a pulse generator 300b, a lead angle adjusting circuit 300c, and a lead angle/frequency converter circuit 300d.

The rotation speed/duty converter circuit 300a sets the duty of the first digital signal (Tsp signal) at a value correlated with the rotation speed of the motor M, the rotation speed being specified by the rotation command. Moreover, the rotation speed/duty converter circuit 300a outputs a duty command signal that indicates the set duty.

For example, the motor driver 200 has six MOS transistors (not shown) that are controlled by a driving control signal. The six MOS transistors are controlled by the driving control signal to supply a three-phase driving voltage to the three-phase coil of the motor M.

The current measuring circuit 100y measures driving currents passing through resistors R1, R2, and R3 that are connected to the three-phase coil via the MOS transistors.

The lead angle adjusting circuit 300c receives the pulse signal outputted from the current/pulse converter circuit 100z through a second port P2. Moreover, the lead angle adjusting circuit 300c obtains the driving current of the motor driver 200 based on the inputted pulse signal.

The lead angle adjusting circuit 300c determines a lead angle in an exploratory manner based on the inputted rotation command and current information to obtain maximum efficiency.

For example, for a minimum current amplitude, the lead angle adjusting circuit 300c varies a lead angle command signal to change the lead angle (search points in FIG. 4). The lead angle adjusting circuit 300c obtains a lead angle where the motor M has the minimum current amplitude in the range of variations of the lead angle (the optimum point of FIG. 4).

The lead angle/frequency converter circuit 300d sets the frequency of the first digital signal at a value correlated with the lead angle of the driving control signal, based on the lead angle specified by the lead angle command signal. Moreover, the lead angle/frequency converter circuit 300d outputs a frequency command signal that indicates the set frequency.

The pulse generator 300b generates and outputs the first digital signal (Tsp signal) that has a duty correlated with information on the specified rotation speed of the motor M and a frequency correlated with information on the specified lead angle, based on the duty command signal and the frequency command signal.

Other configurations are identical to those of the first embodiment.

In the case where a circuit (not shown) is provided for storing beforehand a lead angle having a minimum current amplitude at each rotation speed, the lead angle adjusting circuit and the current measuring circuit may be eliminated, further saving a search process.

For example, as in the first embodiment, the motor driving circuit 100 controls the motor driver 200 (controls the three-phase driving voltage (or the driving current) to the motor M) by the driving control signal based on the first digital signal outputted from the MCU 300, so that the driving of the motor M is controlled.

Specifically, the motor driving circuit 100 generates the driving control signal based on the duty of the first digital signal so as to drive the motor M at the commanded rotation speed, and controls the lead angle of the driving control signal based on the frequency of the first digital signal to improve efficiency.

As described above, the motor driving system 3000 according to the third embodiment can increase the variety of information transmitted through the limited number of ports of the MCU 300.

Furthermore, the number of wires of the MCU 300 and the motor driving circuit 100 can be reduced.

Moreover, the number of terminals (ports) can be reduced, thereby reducing the size and cost of a package. The lead angle can be optimized with a small number of communication lines, achieving higher efficiency.

### Fourth Embodiment

A fourth embodiment will describe another example of the configuration of an MCU for setting the duty and frequency of a first digital signal.

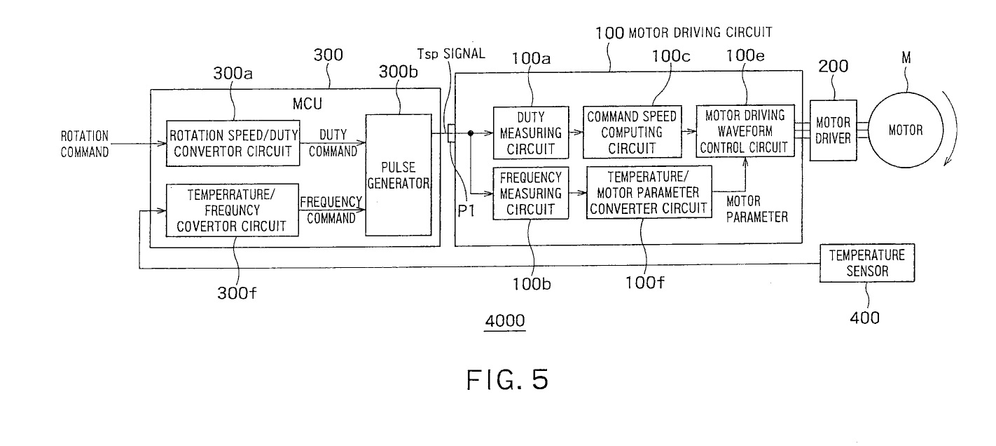

FIG. 5 illustrates an example of the configuration of a motor driving system 4000 according to the fourth embodiment. In FIG. 5, the same reference numerals as in FIG. 1 indicate the same configurations as in the first embodiment unless otherwise explained.

As illustrated in FIG. 5, the motor driving system 4000 includes a motor driving circuit 100, a motor driver 200, an MCU 300, a temperature sensor 400, and a motor M.

As in the first embodiment, the MCU 300 controls the overall operations of products such as air conditioners and refrigerators and controls the driving of fans and compressors in response to a rotation command.

The temperature sensor 400 measures the temperature of the motor M (the temperature of the motor M including a coil and an outer frame and a temperature around the motor M) and outputs a measure signal corresponding to the measured temperature.

The MCU 300 includes, for example, a rotation speed/duty converter circuit 300a, a temperature/frequency converter circuit 300f, and a pulse generator 300b.

The rotation speed/duty converter circuit 300a sets the duty of the first digital signal at a value correlated with the rotation speed of the motor M, the rotation speed being specified by the rotation command. Moreover, the rotation speed/duty converter circuit 300a outputs a duty command signal that indicates the set duty.

The temperature/frequency converter circuit 300f sets, based on the measure signal, the frequency of the first digital signal at a value correlated with the measured temperature and outputs a frequency command signal that indicates the set frequency.

The pulse generator 300b generates and outputs the first digital signal based on the duty command signal and the frequency command signal.

The motor driving circuit 100 includes, for example, a first port P1, a duty measuring circuit 100a, a frequency measuring circuit 100b, a command speed computing circuit 100c, a motor driving waveform control circuit 100e, and a temperature/motor parameter converter circuit 100f.

The first port P1 receives the first digital signal outputted from the MCU 300.

The duty measuring circuit 100a measures the duty of the first digital signal inputted through the first port P1 and outputs a duty information signal corresponding to the measured duty.

The frequency measuring circuit 100b measures the frequency of the first digital signal and outputs a frequency information signal corresponding to the measured frequency of the first digital signal.

The command speed computing circuit 100c computes, based on the duty information signal, the rotation speed of the motor M commanded by the MCU 300 and outputs a rotation speed information signal containing information on the computed rotation speed.

The temperature/motor parameter converter circuit 100f obtains, based on the frequency information signal, the temperature measured by the temperature sensor 400 and outputs a motor parameter information signal containing information on a motor parameter corresponding to the measured temperature.

The motor driving waveform control circuit 100e generates a driving control signal as a PWM signal for driving the motor M at a commanded rotation speed, based on the rotation speed information signal and the motor parameter information signal.

The motor parameter is, for example, a winding resistance, a reactance, and an induced voltage of the motor M.

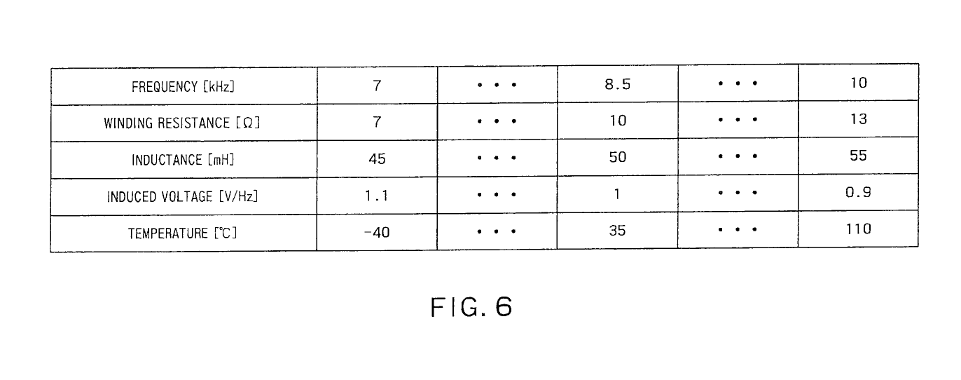

FIG. 6 shows an example of the relationship between a frequency of the first digital signal (Tsp signal) and a selected motor parameter. As shown in FIG. 6, for example, a frequency of 7 kHz is allocated to a measured temperature of 40° C. The values (7Ω, 45 mH, 1.1 V/Hz) of motor parameters (a winging resistance, a reactance, and an induced voltage) at a frequency of 7 kHz are inputted from the temperature/motor parameter converter circuit 100f to the motor driving waveform control circuit 100e.

At a frequency not indicated in FIG. 6, the motor parameters are preferably outputted after interpolation between frequencies shown in FIG. 6. For example, linear interpolation may be used.

As described above, in the case where physical values (motor parameters) such as a winding resistance, a reactance, and an induced voltage of the motor M are changed by a temperature change of the motor M in the motor driving system 3000 of the present embodiment, the setting of the motor driving circuit 100e can be changed accordingly.

Other configurations are identical to those of the first embodiment.

For example, as in the first embodiment, the motor driving circuit 100 controls the motor driver 200 (controls the three-phase driving voltage (or the driving current) to the motor M) by the driving control signal based on the first digital signal outputted from the MCU 300, so that the driving of the motor M is controlled.

Specifically, the motor driving circuit 100 generates the driving control signal based on the duty of the first digital signal so as to drive the motor M at the commanded rotation speed, and controls the driving control signal based on the frequency of the first digital signal to improve efficiency.

As described above, the motor driving system 4000 according to the fourth embodiment can increase the variety of information transmitted through the limited number of ports of the MCU 300.

Furthermore, the number of wires of the MCU 300 and the motor driving circuit 100 can be reduced.

Moreover, the number of terminals (ports) can be reduced, thereby reducing the size and cost of a package. Moreover, efficient control can be achieved with a small number of communication ports in consideration of a temperature.

### Fifth Embodiment

A fifth embodiment will describe still another example of the configuration of an MCU for setting the duty and frequency of a first digital signal.

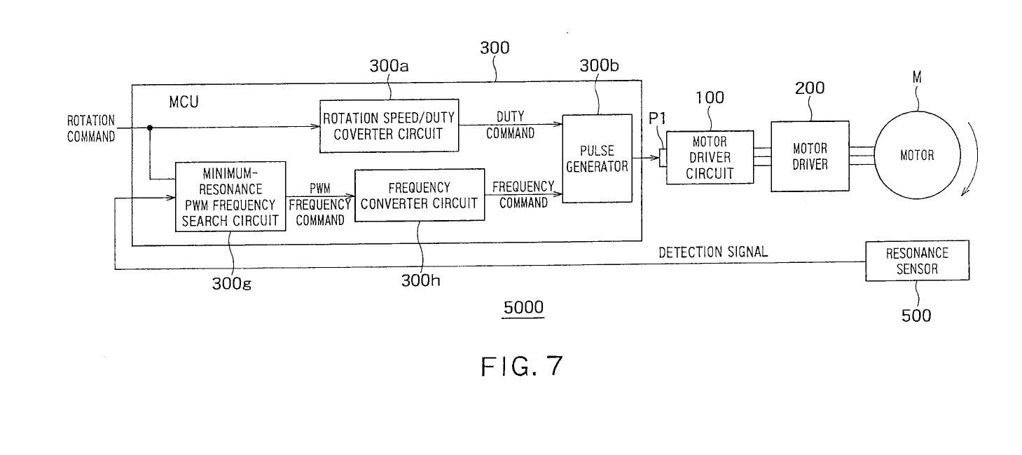

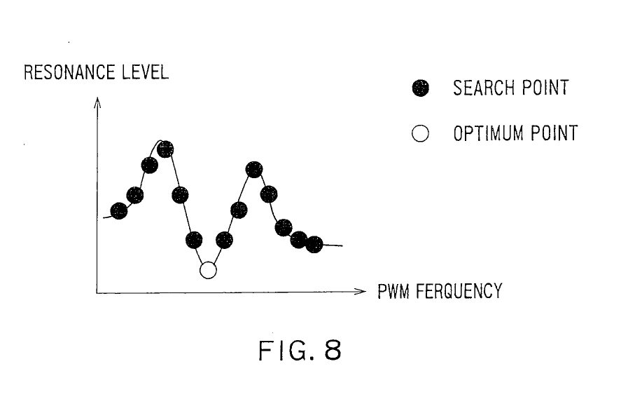

FIG. 7 illustrates an example of the configuration of a motor driving system 5000 according to the fifth embodiment. FIG. 8 shows an example of the relationship between a resonance level of the motor M and a PWM frequency. In FIG. 7, the same reference numerals as in FIG. 1 indicate the same configurations as in the first embodiment unless otherwise explained.

As illustrated in FIG. 7, the motor driving system 5000 includes a motor driving circuit 100, a motor driver 200, an MCU 300, a resonance sensor 500, and the motor M.

The resonance sensor 500 measures the resonance of the motor M and output a measure signal corresponding to the level of the measured resonance.

As in the first embodiment, the MCU 300 controls the overall operations of products such as air conditioners and refrigerators and controls the driving of fans and compressors in response to a rotation command.

The MCU 300 includes a rotation speed/duty converter circuit 300a, a pulse generator 300b, a minimum-resonance PWM frequency search circuit 300g, and a frequency converter circuit 300h.

The rotation speed/duty converter circuit 300a sets the duty of the first digital signal at a value correlated with the rotation speed of the motor M, the rotation speed being specified by the rotation command. Moreover, the rotation speed/duty converter circuit 300a outputs a duty command signal that indicates the set duty.

The minimum-resonance PWM frequency search circuit 300g outputs a PWM frequency command signal that indicates the PWM frequency of the driving control signal, based on the rotation speed of the motor M and the measure signal, the rotation speed being specified by the rotation command.

The frequency converter circuit 300h sets, based on the PWM frequency command signal, the frequency of the first digital signal at a value correlated with the indicated PWM frequency and outputs a frequency command signal that indicates the set frequency.

The pulse generator 300b generates and outputs the first digital signal based on the duty command signal and the frequency command signal.

The minimum-resonance PWM frequency search circuit 300g obtains a resonance level from the measure signal. For example, the minimum-resonance PWM frequency search circuit 300g changes the PWM frequency command signal to vary the PWM frequency (search points in FIG. 8). Furthermore, the minimum-resonance PWM frequency search circuit 300g obtains a PWM frequency where the motor M has minimum resonance in the range of variations of the PWM frequency (the optimum point of FIG. 8).

Thus, the MCU 300 receives information on a resonance level (set noise or the like) and automatically (in an explanatory manner) changes the PWM frequency command (FIG. 8). The PWM frequency command can be used for, for example, an application for minimizing resonance.

Other configurations are identical to those of the first embodiment.

In the case where a circuit (not shown) is provided for storing beforehand a minimum resonance frequency at each rotation speed, an optimum search unit and the sensor may be eliminated, further saving a search process.

For example, as in the first embodiment, the motor driving circuit 100 controls the motor driver 200 (controls a three-phase driving voltage (or a driving current) to the motor M) by the driving control signal based on the first digital signal outputted from the MCU 300, so that the driving of the motor M is controlled.

Specifically, the motor driving circuit 100 generates the driving control signal based on the duty of the first digital signal so as to drive the motor M at a commanded rotation speed, and controls the PWM frequency of the driving control signal based on the frequency of the first digital signal so as to reduce resonance.

As described above, the motor driving system 5000 according to the fifth embodiment can increase the variety of information transmitted through the limited number of ports of the MCU 300.

Furthermore, the number of wires of the MCU 300 and the motor driving circuit 100 can be reduced.

Moreover, the number of terminals (ports) can be reduced, thereby reducing the size and cost of a package. Additionally, resonance can be minimized with a small number of ports, achieving a set with high quietness.

### Sixth Embodiment

In the configuration example of the fifth embodiment, the MCU includes the minimum-resonance PWM frequency search circuit.

A sixth embodiment will describe a configuration example in which a motor driving circuit includes a minimum-resonance PWM frequency search circuit.

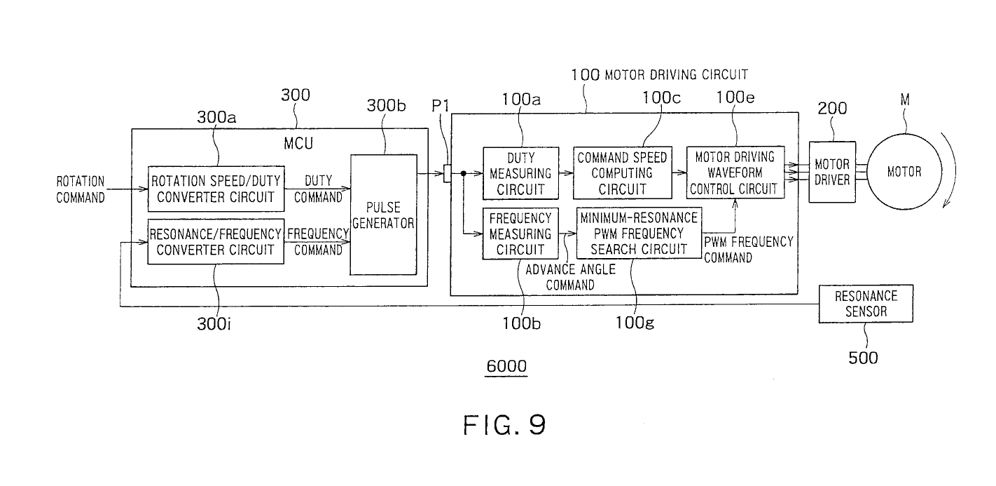

FIG. 9 illustrates an example of the configuration of a motor driving system 6000 according to a sixth embodiment. In FIG. 9, the same reference numerals as in FIG. 1 indicate the same configurations as in the first embodiment unless otherwise explained.

As illustrated in FIG. 9, the motor driving system 6000 includes a motor driving circuit 100, a motor driver 200, an MCU 300, a resonance sensor 500, and a motor M.

The resonance sensor 500 measures the resonance of the motor M and outputs a measure signal corresponding to the level of the measured resonance.

The MCU 300 includes an rotation speed/duty converter circuit 300a, a pulse generator 300b, and a resonance/frequency converter circuit 300i.

The rotation speed/duty converter circuit 300a sets the duty of a first digital signal at a value correlated with the rotation speed of the motor M, the rotation speed being specified by a rotation command. Moreover, the rotation speed/duty converter circuit 300a outputs a duty command signal that indicates the set duty.

The resonance/frequency converter circuit 300i obtains the level of the measured resonance based on the measure signal. Furthermore, the resonance/frequency converter circuit 300i sets the frequency of the first digital signal at a value correlated with the level of the measured resonance and outputs a frequency command signal that indicates the set frequency.

The pulse generator 300b generates and outputs the first digital signal based on the duty command signal and the frequency command signal.

As illustrated in FIG. 9, the motor driving circuit 100 includes, for example, a first port P1, a duty measuring circuit 100a, a frequency measuring circuit 100b, a command speed computing circuit 100c, a motor driving waveform control circuit 100e, and a minimum-resonance PWM frequency search circuit 100g.

The first port P1 receives the first digital signal outputted from the MCU 300.

The duty measuring circuit 100a measures the duty of the first digital signal inputted through the first port P1 and outputs a duty information signal corresponding to the measured duty.

The frequency measuring circuit 100b measures the frequency of the first digital signal and outputs a frequency information signal corresponding to the measured frequency of the first digital signal. The frequency information signal contains information on the resonance level.

The command speed computing circuit 100c computes, based on the duty information signal, the rotation speed of the motor M commanded by the MCU 300 and outputs a rotation speed information signal containing information on the computed rotation speed.

The minimum-resonance PWM frequency search circuit 100g obtains the resonance level of the motor M based on the frequency information signal and outputs a PWM frequency command signal that indicates the PWM frequency of the driving control signal based on the level of the obtained resonance.

The motor driving waveform control circuit 100e generates a driving control signal as a PWM signal for driving the motor M at a commanded rotation speed, based on the rotation speed information signal and the PWM frequency command signal.

The minimum-resonance PWM frequency search circuit 100g changes the PWM frequency command signal to vary the PWM frequency (the search points in FIG. 8). The minimum resonance PWM frequency search circuit 100g obtains a PWM frequency where the motor M has minimum resonance in the range of variations of the PWM frequency (the optimum point of FIG. 8).

Thus, the motor driving circuit 100 receives information on a resonance level (set noise or the like) and automatically (in an explanatory manner) changes the PWM frequency command (FIG. 8). The PWM frequency command can be used for, for example, an application for minimizing resonance.

In the case where another circuit (not shown) is provided for storing the relationship between the minimum resonance frequency and a rotation speed without containing resonance information (at a frequency not allocated to the resonance information), the resonance sensor and the minimum-resonance PWM frequency search circuit may be eliminated by using information about the relationship, thereby omitting a search process.

Other configurations are identical to those of the first embodiment.

For example, as in the first embodiment, the motor driving circuit 100 controls the motor driver 200 (controls a three-phase driving voltage (or a driving current) to the motor M) by the driving control signal based on the first digital signal outputted from the MCU 300, so that the driving of the motor M is controlled.

Specifically, the motor driving circuit 100 generates the driving control signal based on the duty of the first digital signal so as to drive the motor M at the commanded rotation speed, and controls the PWM frequency of the driving control signal based on the frequency of the first digital signal so as to minimize resonance.

As described above, the motor driving system 6000 according to the sixth embodiment can increase the variety of information transmitted through the limited number of ports of the MCU 300.

Furthermore, the number of wires of the MCU 300 and the motor driving circuit 100 can be reduced.

Moreover, the number of terminals (ports) can be reduced, thereby reducing the size and cost of a package.

Additionally, resonance can be minimized with a small number of ports, achieving a set with high quietness.

The correlation may be reversed as in the case where the frequency of the first digital signal and the rotation speed of the motor M are correlated with each other while the duty of the first digital signal and a control parameter are correlated with each other in the second embodiment.

### Seventh Embodiment

In the first embodiment, the motor driving circuit includes the single control parameter computing circuit, that is, the single control parameter.

In a seventh embodiment, a motor driving circuit includes a plurality of control parameter computing circuits to be switched. In other words, multiple control parameters and command speed updates are switched.

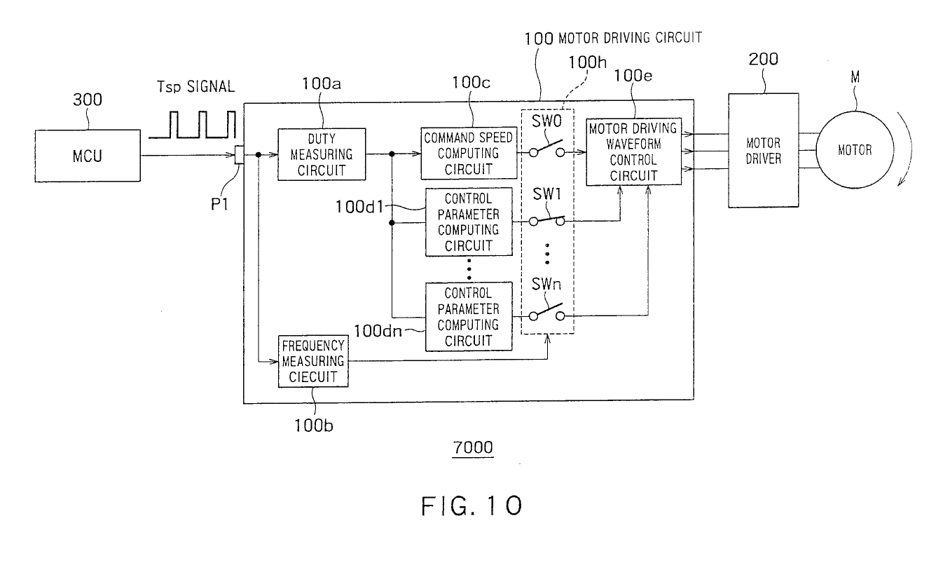

FIG. 10 illustrates an example of the configuration of a motor driving system 7000 according to the seventh embodiment. In FIG. 10, the same reference numerals as in FIG. 1 indicate the same configurations as in the first embodiment unless otherwise explained.

As illustrated in FIG. 10, the motor driving system 7000 includes a motor driving circuit 100, a motor driver 200, an MCU 300, and a motor M.

The motor driving circuit 100 includes, for example, a first port P1, a duty measuring circuit 100a, a frequency measuring circuit 100b, a command speed computing circuit 100c, multiple control parameter computing circuits 100d1 to 100dn (n≧1), a motor driving waveform control circuit 100e, and an output switching circuit 100h.

The first port P1 receives a first digital signal outputted from the MCU 300.

The duty measuring circuit 100a measures the duty of the first digital signal inputted through the first port P1 and outputs a duty information signal corresponding to the measured duty.

The frequency measuring circuit 100b measures the frequency of the first digital signal and outputs a frequency information signal corresponding to the measured frequency of the first digital signal.

The command speed computing circuit 100c computes, based on the duty information signal, the rotation speed of the motor M commanded by the MCU 300 and outputs a rotation speed information signal containing information on the computed rotation speed.

The control parameter computing circuits 100d1 to 100dn compute, based on the duty information signal, first to n-th control parameters for adjusting the drive control of the motor M commanded by the MCU 300. Moreover, the control parameter computing circuits 100d1 to 100dn output first to n-th control parameter information signals, respectively, containing information on the computed first to n-th control parameters.

The first to n-th control parameters are, for example, the PWM frequency of a driving control signal, the dead time of the driving control signal, the pattern of motor driving waveform of the driving control signal, the control timing of the driving control signal (e.g., a DC excitation time for fixing a rotor at a predetermined position), a current controller gain for passing a desired current through the motor M or a speed controller gain for rotations at a desired rotation speed (a current controller and a speed controller are both disposed in a motor driving waveform control unit but are not shown in FIG. 10), and the lead angle of the driving control signal, respectively.

For example, a dead time, a PWM frequency, a motor parameter, and a lead angle require fine adjustments in a narrow range and thus are preferably plotted on a linear scale on a table for setting the control parameters. A control gain and control timing require wide-range adjustments and thus are preferably plotted on a logarithmic scale on the table for setting the control parameters.

In the case of a high control gain, the convergence time of controlled variables (including a speed, a position, and a current value) is shortened. Thus, the control gain and the control timing are preferably changed in a pair.

In the case of a high PWM frequency (a short period), the influence of a dead time grows. Hence, the PWM frequency and the dead time are preferably changed in a pair. For example, the PWM frequency and the dead time are changed with a constant ratio.

The output switching circuit 100h switches and outputs the rotation speed information signal or first to n-th control parameter information signals based on the frequency information signal.

As illustrated in FIG. 10, the output switching circuit 100h includes, for example, n+1 switching circuits sw0 to swn.

The switching circuit sw0 is, for example, connected between the output of the command speed computing circuit 100c and the input of the motor driving waveform control circuit 100e. When the switching circuit sw0 is selected and turned on based on the frequency information signal, the switching circuit sw0 transmits the rotation speed information signal from the command speed computing circuit 100c to the motor driving waveform control circuit 100e.

The switching circuit sw1 is, for example, connected between the output of the first control parameter computing circuit 100d1 and the input of the motor driving waveform control circuit 100e. When the switching circuit sw1 is selected and turned on based on the frequency information signal, the switching circuit sw1 transmits the first control parameter information signal outputted from the first control parameter computing circuit 100d1 to the motor driving waveform control circuit 100e.

Likewise, the switching circuit swn is, for example, connected between the output of the n-th control parameter computing circuit 100dn and the input of the motor driving waveform control circuit 100e. When the switching circuit swn is selected and turned on based on the frequency information signal, the switching circuit swn transmits the n-th control parameter information signal outputted from the n-th control parameter computing circuit 100dn to the motor driving waveform control circuit 100e.

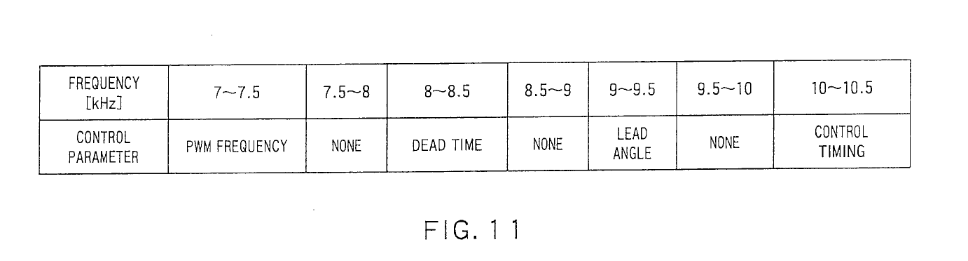

FIG. 11 illustrates an example of the relationship between the frequency of the first digital signal (Tsp signal) and the control parameters to be selected.

As illustrated in FIG. 11, for example, at a frequency of 7 kHz to 7.5 kHz, the switching circuit sw1 is turned on and information on the PWM frequency is inputted as a control parameter from the first control parameter computing circuit 100d1 to the motor driving waveform control circuit 100e.

For example, at a frequency of 9 kHz to 9.5 kHz, the switching circuit swn is turned on and information on a lead angle is inputted as a control parameter from the n-th control parameter computing circuit 100dn to the motor driving waveform control circuit 100e.

Furthermore, frequency bands not allocated to the control parameters are provided between the frequencies allocated to the control parameters. Thus, the control parameters can be changed without causing interference.

As illustrated in FIG. 10, the motor driving waveform control circuit 100e generates a driving control signal as a PWM signal for driving the motor M at a commanded rotation speed, based on the rotation speed information signal and the control parameter information signals that are switched and inputted from the output switching circuit 100h.

The motor driving waveform control circuit 100e holds a rotation speed contained in the rotation speed information signal and information on the control parameters. As described above, the motor driving waveform control circuit 100e receives the switched first to n-th control parameter information signals and obtains the information on the control parameters from the inputted control parameter information signals. Furthermore, the motor driving waveform control circuit 100e generates the driving control signal as a PWM signal for driving the motor M at the commanded rotation speed, based on the rotation speed and the value of the obtained control parameter.

Thus, the motor driving circuit 100 of the present embodiment can adjust the multiple control parameters through the single port.

Other configurations are identical to those of the first embodiment.

In other words, the motor driving system 7000 according to the seventh embodiment can increase the variety of information transmitted through the limited number of ports of the MCU 300.

Furthermore, the number of wires of the MCU 300 and the motor driving circuit 100 can be reduced.

Moreover, the number of terminals (ports) can be reduced, thereby reducing the size and cost of a package.

The correlation may be reversed as in the case where the frequency of the first digital signal and the rotation speed of the motor M are correlated with each other while the duty of the first digital signal and the control parameter are correlated with each other in the second embodiment.

### Eighth Embodiment

In the seventh embodiment, the control parameters are switched based on the frequency of the first digital signal inputted from the MCU 300 to the first port.

In an eighth embodiment, control parameters are switched based on a switching signal inputted from an MCU 300 to an additional port.

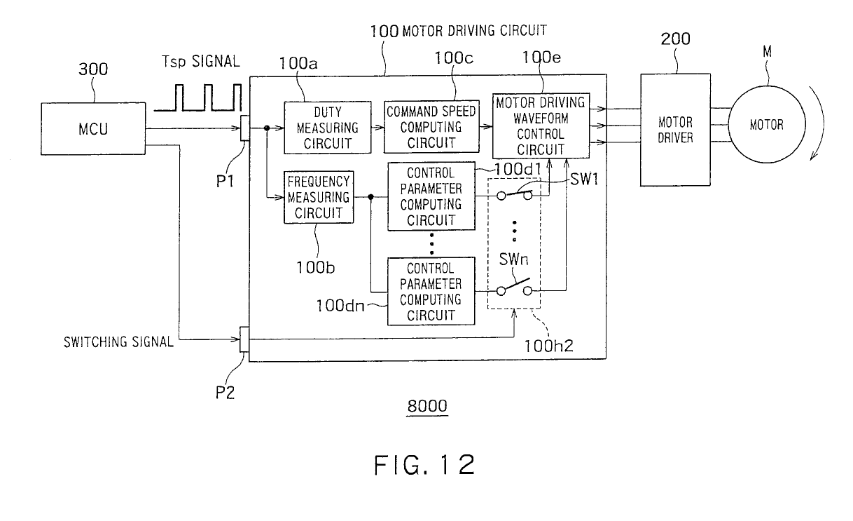

FIG. 12 illustrates an example of the configuration of a motor driving system 8000 according to the eighth embodiment. In FIG. 12, the same reference numerals as in FIG. 10 indicate the same configurations as in the seventh embodiment unless otherwise explained.

As illustrated in FIG. 12, the motor driving system 8000 includes a motor driving circuit 100, a motor driver 200, the MCU 300, and a motor M.

The motor driving circuit 100 includes, for example, a first port P1, a second port P2, a duty measuring circuit 100a, a frequency measuring circuit 100b, a command speed computing circuit 100c, control parameter computing circuits 100d1 to 100dn (n≧2), a motor driving waveform control circuit 100e, and an output switching circuit 100h2.

The first port P1 receives a first digital signal outputted from the MCU 300.

The second port P2 receives a switching signal outputted from the MCU 300.

The duty measuring circuit 100a measures the duty of the first digital signal inputted through the first port P1 and outputs a duty information signal corresponding to the measured duty.

The frequency measuring circuit 100b measures the frequency of the first digital signal and outputs a frequency information signal corresponding to the measured frequency of the first digital signal.

The command speed computing circuit 100c computes the rotation speed of the motor M commanded by the MCU 300, based on the duty information signal. Moreover, the command speed computing circuit 100c outputs a rotation speed information signal containing information on the computed rotation speed.

The first control parameter computing circuit 100d1 computes a first control parameter for adjusting the drive control of the motor M commanded by the MCU 300, for example, based on the frequency information signal. Moreover, the first control parameter computing circuit 100d1 outputs a first control parameter information signal containing information on the computed first control parameter.

Likewise, the n-th control parameter computing circuit 100dn computes, for example, an n-th control parameter based on the frequency information signal. The n-th control parameter is different from the first control parameter for adjusting the drive control of the motor M commanded by the MCU 300. The n-th control parameter computing circuit 100dn outputs an n-th control parameter information signal containing information on the computed n-th control parameter.

The output switching circuit 100h2 switches and outputs first to n-th control parameter information signals based on the switching signal inputted through the second port P2.

The motor driving waveform control circuit 100e generates a driving control signal as a PWM signal for driving the motor M at a commanded rotation speed, based on the rotation speed information signal inputted from the command speed computing circuit 100c and the first to n-th control parameter information signals that are switched and inputted from the output switching circuit 100h2.

As described above, in the eighth embodiment, the motor driving circuit 100 further includes the second port P2 to change a control parameter to be updated. Thus, the rotation speed and the control parameter can be changed substantially at the same time, efficiently adjusting the control parameter whose optimal value is variable at each rotation speed.

Other configurations are identical to those of the first embodiment.

In other words, the motor driving system 8000 according to the eighth embodiment can increase the variety of information transmitted through the limited number of ports of the MCU 300.

Furthermore, the number of wires of the MCU 300 and the motor driving circuit 100 can be reduced.

Moreover, the number of terminals (ports) can be reduced, thereby reducing the size and cost of a package.

The correlation may be reversed as in the case where the frequency of the first digital signal and the rotation speed of the motor M are correlated with each other while the duty of the first digital signal and the control parameter are correlated with each other in the second embodiment.

### Ninth Embodiment

In the eighth embodiment, the control parameters are switched based on the switching signal inputted to the additional port from the MCU 300.

In a ninth embodiment, motor information is switched and outputted from an additional port to an MCU 300 based on the frequency of a first digital signal.

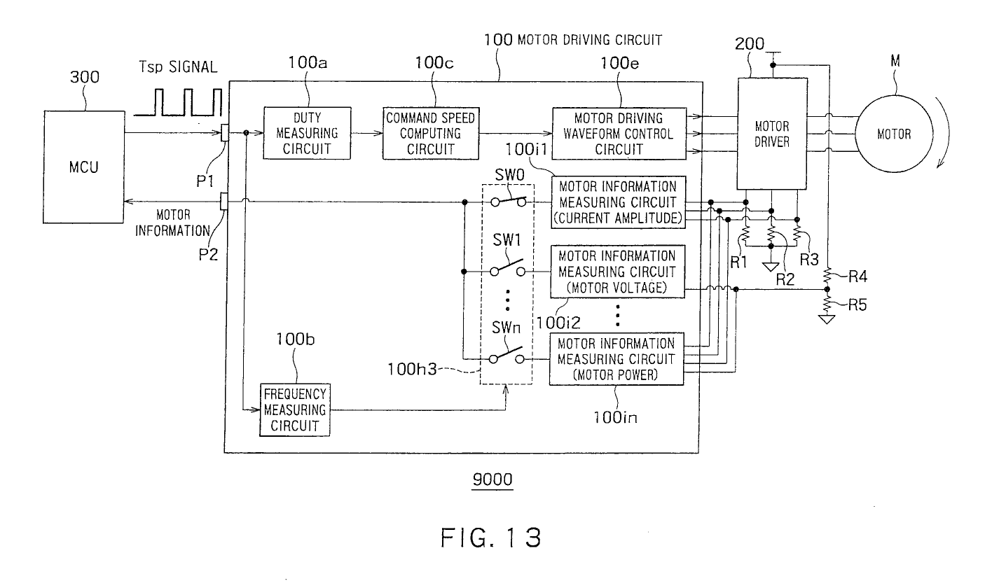

FIG. 13 illustrates an example of the configuration of a motor driving system 9000 according to the ninth embodiment. In

FIG. 13, the same reference numerals as in FIG. 1 indicate the same configurations as in the first embodiment unless otherwise explained.

As illustrated in FIG. 13, the motor driving system 9000 includes a motor driving circuit 100, a motor driver 200, the MCU 300, and a motor M.

The motor driving circuit 100 includes, for example, a first port P1, a second port P2, a duty measuring circuit 100a, a frequency measuring circuit 100b, a command speed computing circuit 100c, motor information measuring circuits 100i1 to 100in (n≧2), a motor driving waveform control circuit 100e, and an output switching circuit 100h3.

The first port P1 receives the first digital signal outputted from the MCU 300.

The duty measuring circuit 100a measures the duty of the first digital signal inputted through the first port P1 and outputs a duty information signal corresponding to the measured duty.

The frequency measuring circuit 100b measures the frequency of the first digital signal and outputs a frequency information signal corresponding to the measured frequency of the first digital signal.

The command speed computing circuit 100c computes, based on the duty information signal, the rotation speed of the motor M commanded by the MCU 300 and outputs a rotation speed information signal containing information on the computed rotation speed.

The motor driving waveform control circuit 100e generates, based on the rotation speed information signal, a driving control signal as a PWM signal for driving the motor M at a commanded rotation speed.

The first motor information measuring circuit 100i1 measures first motor information on the driving of the motor M and outputs a first motor information signal corresponding to the measured first motor information.

The second motor information measuring circuit 100i2 measures second motor information that is different from the first motor information on the driving of the motor M, and outputs a second motor information signal corresponding to the measured second motor information.

Likewise, the n-th motor information measuring circuit 100in measures n-th motor information that is different from the first to n−1-th motor information on the driving of the motor M, and outputs an n-th motor information signal corresponding to the measured n-th motor information.

The first to n-th motor information includes a driving current (current amplitude) supplied to the motor M, a motor voltage supplied to the motor M, a motor power consumed in the motor M, the rotation speed of the motor M, and a frequency generator (FG) signal

The motor information measuring circuits may each output a motor current amplitude, a motor voltage, a motor power, and a motor rotation speed after pulse conversion. Additionally, the motor information measuring circuits may each have an H/L output of comparison results with a predetermined threshold value. In the pulse conversion, modulation into either a frequency or a duty is applicable. Furthermore, communication interfaces such as I2C, UART, and SPI may be used.

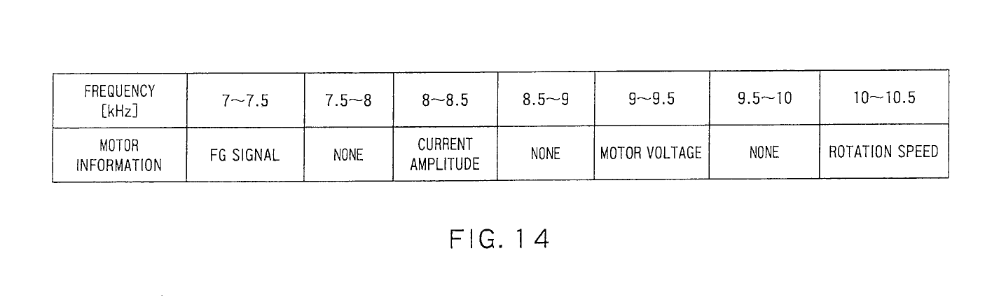

FIG. 14 illustrates an example of the relationship between a frequency of the first digital signal (Tsp signal) and the motor information to be selected.

As shown in FIG. 14, for example, at a frequency of 8 kHz to 8.5 kHz, a switching circuit sw0 is turned on to output a current amplitude as motor information from the first motor information measuring circuit 10011 to the second port P2.

For example, at a frequency of 9 kHz to 9.5 kHz, a switching circuit sw1 is turned on to output a motor voltage as motor information from the n-th motor information measuring circuit 100in to the second port P2.

Furthermore, frequency bands not allocated to the motor information are provided between frequencies allocated to the motor information. Thus, the motor information can be changed without causing interference.

As illustrated in FIG. 13, the output switching circuit 100h3 switches and outputs the first motor information signal and the second motor information signal.

As illustrated in FIG. 13, the output switching circuit 100h3 includes, for example, n switching circuits sw1 to swn.

For example, the switching circuit sw1 is connected between the output of the first motor information measuring circuit 100i2 and the second port P2. When the switching circuit sw1 is selected and turned on based on the frequency information signal, the switching circuit sw1 transmits the first motor information signal outputted from the first motor information measuring circuit 100i1 to the second port p2.

Likewise, the switching circuit swn is, for example, connected between the output of the n-th motor information measuring circuit 100in and the second port P2. When the switching circuit swn is selected and turned on based on the frequency information signal, the switching circuit swn transmits the n-th motor information signal outputted from the n-th motor information measuring circuit 100in to the second port p2.

The second port P2 outputs the signals outputted from the output switching circuit 100h3 to the MCU 300.

Thus, the motor driving circuit 100 of the present embodiment can output a plurality of pieces of motor information through the single port.

Other configurations are identical to those of the first embodiment.

Specifically, the motor driving system 9000 according to the ninth embodiment can increase the variety of information transmitted through the limited number of ports of the MCU 300.

Furthermore, the number of wires of the MCU 300 and the motor driving circuit 100 can be reduced.

Moreover, the number of terminals (ports) can be reduced, thereby reducing the size and cost of a package.

The correlation may be reversed as in the case where the frequency of the first digital signal and the rotation speed of the motor M are correlated with each other while the duty of the first digital signal and a control parameter are correlated with each other in the second embodiment.

### Tenth Embodiment

In a tenth embodiment, the influence of noise contained in a first digital signal (Tsp signal) is lessened based on the frequency of the first digital signal.

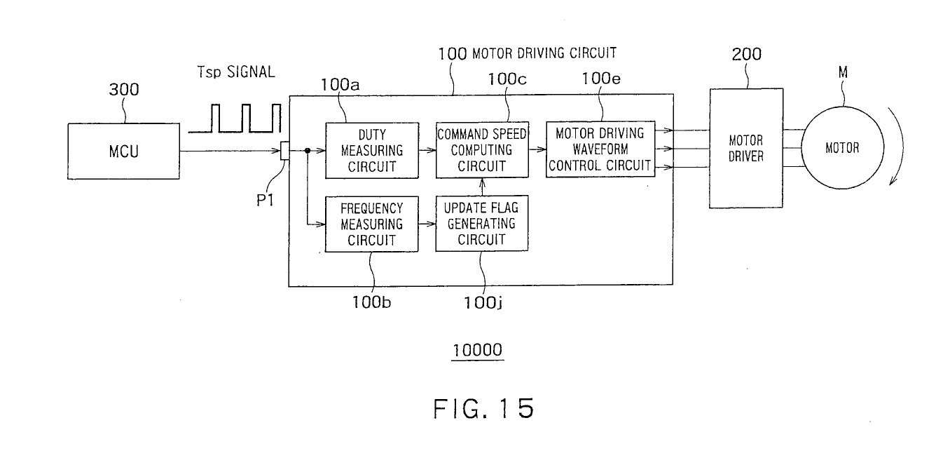

FIG. 15 illustrates an example of the configuration of a motor driving system 10000 according to the tenth embodiment. In FIG. 15, the same reference numerals as in FIG. 1 indicate the same configurations as in the first embodiment unless otherwise explained.

As illustrated in FIG. 15, the motor driving system 10000 includes a motor driving circuit 100, a motor driver 200, an MCU 300, and a motor M.

The motor driving circuit 100 includes, for example, a first port P1, a duty measuring circuit 100a, a frequency measuring circuit 100b, a command speed computing circuit 100c, a motor driving waveform control circuit 100e, and an update flag generating circuit 100j.

The first port P1 receives the first digital signal outputted from the MCU 300.

The duty measuring circuit 100a measures the duty of the first digital signal inputted through the first port P1 and outputs a duty information signal corresponding to the measured duty.

The frequency measuring circuit 100b measures the frequency of the first digital signal and outputs a frequency information signal corresponding to the measured frequency of the first digital signal.

The update flag generating circuit 100j outputs an update flag signal in the case where a change of the frequency information signal is smaller than a predetermined threshold value. The update flag generating circuit 100j stops outputting the update flag signal in the case where a change of the frequency information signal is equal to or larger than the threshold value.

The command speed computing circuit 100c computes, based on the duty information signal, the rotation speed of the motor M commanded by the MCU 300 and outputs a rotation speed information signal containing information on the computed rotation speed.

The command speed computing circuit 100c outputs the rotation speed information signal in response to the update flag signal. Thus, in the case where the update flag generating circuit 100j stops outputting the update flag signal, the command speed computing circuit 100c stops outputting the rotation speed information signal. In other words, an update to a rotation speed command is stopped.

The motor driving waveform control circuit 100e generates a driving control signal as a PWM signal for driving the motor M at a commanded rotation speed, based on the rotation speed information signal.

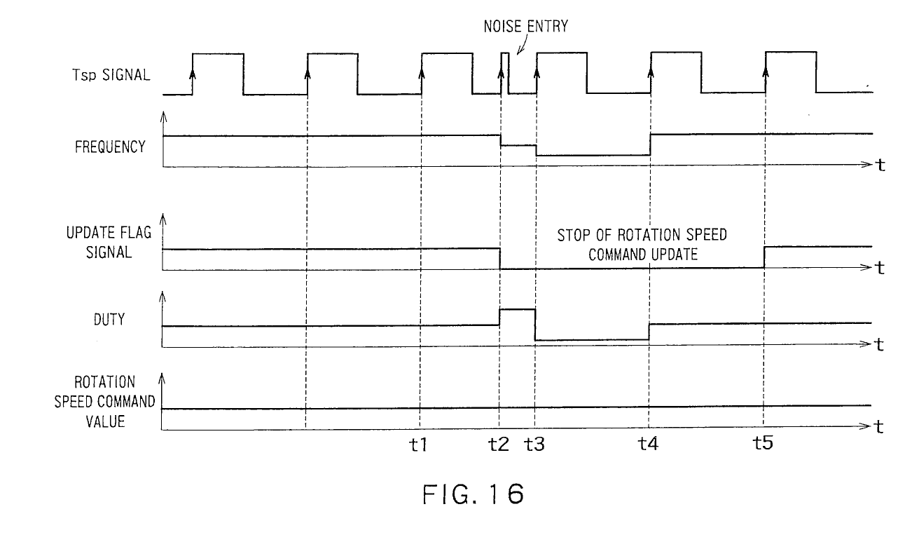

FIG. 16 is a waveform chart showing an example of the waveforms of the first digital signal (Tsp signal), a measured frequency, a measured duty, the update flag signal, and a rotation speed command value.

As shown in FIG. 16, until time t1, the frequency remains constant and the update flag signal is outputted (“High” level). The rotation speed command remains constant.

At time t2, the frequency and the duty fluctuate in response to the entry of noise into the first digital signal. In the case where a change of the frequency (a change of the frequency information signal) is equal to or larger than the threshold value, the update flag generating circuit 100j stops outputting the update flag signal (“Low” level). Thus, the command speed computing circuit 100c stops outputting the rotation speed information signal. In other words, an update to the rotation speed command is stopped.

It is therefore possible to prevent an erroneous update of the rotation speed command when the duty is changed by the entry of noise.

When the first digital signal returns to normal (time t3), the measurement results of the frequency and the duty return to normal (time t4). When a change of the frequency (a change of the frequency information signal) is smaller than the threshold value, the update flag generating circuit 100j outputs the update flag signal (time t5).

As described above, the frequency is used as communication stability information and an update to the rotation speed command value is stopped in the case of large frequency fluctuations, enabling robust rotation speed control.

Particularly, in the case where the motor M has a large power, noise tends to be frequently superimposed on the first digital signal (Tsp signal). In the motor driving system 10000 of the present embodiment, however, the influence of noise is negligible, achieving a robust rotation speed command.

Other configurations are identical to those of the first embodiment.

The correlation may be reversed as in the case where the frequency of the first digital signal and the rotation speed of the motor M are correlated with each other while the duty of the first digital signal and a control parameter are correlated with each other in the second embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A motor driving circuit that controls driving of a motor based on communications with an external MCU,
the motor driving circuit comprising:
a first port that receives a first digital signal outputted from the MCU;
a duty measuring circuit that measures a duty of the first digital signal inputted through the first port and outputs a duty information signal corresponding to the measured duty; and
a frequency measuring circuit that measures a frequency of the first digital signal and outputs a frequency information signal corresponding to the measured frequency of the first digital signal.

2. The motor driving circuit according to claim 1, further comprising
a command speed computing circuit that computes, based on one of the duty information signal and the frequency information signal, a rotation speed of the motor commanded by the MCU and outputs a rotation speed information signal containing information on the computed rotation speed; and
a motor driving waveform control circuit that generates a driving control signal as a PWM signal for driving the motor at a commanded rotation speed, based on information obtained by the rotation speed information signal and the other of the duty information signal and the frequency information signal.

3. The motor driving circuit according to claim 2, further comprising a control parameter computing circuit that computes, based on the other of the duty information signal and the frequency information signal, a control parameter for adjusting drive control of the motor commanded by the MCU and outputs a control parameter information signal containing information on the computed control parameter,
wherein the motor driving waveform control circuit generates the driving control signal as a PWM signal for driving the motor at the commanded rotation speed, based on the rotation speed information signal and the control parameter information signal.

4. The motor driving circuit according to claim 3, wherein the control parameter is one of a PWM frequency of the driving control signal, a dead time of the driving control signal, a pattern of motor driving waveform of the driving control signal, a control timing of the driving control signal, a current controller gain for passing a desired current through the motor, a speed controller gain for rotations at a desired rotation speed, and the lead angle of the driving control signal.

5. The motor driving circuit according to claim 1, further comprising
a command speed computing circuit that computes, based on the one of the duty information signal and the frequency information signal, a rotation speed of the motor commanded by the MCU and outputs a rotation speed information signal containing information on the computed rotation speed;
a first control parameter computing circuit that computes, based on the one of the duty information signal and the frequency information signal, a first control parameter for adjusting drive control of the motor commanded by the MCU and outputs a control parameter information signal containing information on the computed control parameter;
a second control parameter computing circuit that computes, based on the other of the duty information signal and the frequency information signal, a second control parameter different from a first control parameter for adjusting drive control of the motor commanded by the MCU, and outputs a second control parameter information signal containing information on the computed second control parameter;
an output switching circuit that switches and outputs one of the rotation speed information signal and the first control parameter information signal based on the other of the duty information signal and the frequency information signal; and
a motor driving waveform control circuit that generates a driving control signal as a PWM signal for driving the motor at a commanded rotation speed, based on the rotation speed information signal inputted and the first control parameter information that are switched and inputted from the output switching circuit.

6. The motor driving circuit according to claim 1, further comprising
a command speed computing circuit that computes, based on the one of the duty information signal and the frequency information signal, a rotation speed of the motor commanded by the MCU and outputs a rotation speed information signal containing information on the computed rotation speed;
a first control parameter computing circuit that computes, based on the one of the duty information signal and the frequency information signal, a first control parameter for adjusting drive control of the motor commanded by the MCU and outputs a control parameter information signal containing information on the computed control parameter;
a second control parameter computing circuit that computes, based on the other of the duty information signal and the frequency information signal, a second control parameter different from a first control parameter for adjusting drive control of the motor commanded by the MCU, and outputs a second control parameter information signal containing information on the computed second control parameter;
an output switching circuit that switches and outputs one of a first control parameter information signal and the second control parameter information signal based on a switching signal inputted through a second port; and
a motor driving waveform control circuit that generates a driving control signal as a PWM signal for driving the motor at a commanded rotation speed, based on the rotation speed information signal inputted from a command speed computing circuit and one of the first control parameter information signal and the second control parameter information signal that are switched and inputted from the output switching circuit.

7. The motor driving circuit according to claim 1, further comprising a first motor information measuring circuit that measures first motor information on the driving of the motor and outputs a first motor information signal corresponding to the measured first motor information;
a second motor information measuring circuit that measures second motor information different from the first motor information on the driving of the motor and outputs a second motor information signal corresponding to the measured second motor information;
an output switching circuit that switches and outputs one of the first motor information signal and the second motor information signal based on the other of the duty information signal and the frequency information signal; and
a second port that outputs the signal outputted from the output switching circuit to the MCU.

8. The motor driving circuit according to claim 1, wherein the motor information includes a driving current supplied to the motor, a motor voltage supplied to the motor, a motor power consumed in the motor, the rotation speed of the motor.

9. The motor driving circuit according to claim 1, further comprising
an update flag generating circuit that outputs an update flag signal in the case where a change of the other of the duty information signal and the frequency information signal is smaller than a predetermined threshold value, and stops outputting the update flag signal in the case where the change of the other of the duty information signal and the frequency information signal is equal to or larger than the threshold value; and
a motor driving waveform control circuit that generates, based on a rotation speed information signal, a driving control signal as a PWM signal for driving the motor at a commanded rotation speed,
wherein a command speed computing circuit outputs the rotation speed information signal in response to the update flag signal.

10. A motor driving circuit that controls driving of a motor based on communications with an external MCU,
the motor driving circuit generating a driving control signal as a PWM signal for driving the motor at a commanded rotation speed, based on a rotation speed obtained according to one of a duty and a frequency of a first digital signal outputted from the MCU and information obtained based on the other of the duty and the frequency of the first digital signal.

11. The motor driving circuit according to claim 1, wherein the motor is a three-phase motor.

12. A motor driving system comprising:
a motor;
a motor driver that supplies, to the motor, a driving current for driving the motor;
an MCU that outputs a first digital signal corresponding to a rotation command; and
a motor driving circuit that controls driving of the motor by controlling the motor driver in response to a driving control signal based on the first digital signal.

13. The motor driving system according to claim 12, wherein the motor driving circuit comprises a current measuring circuit that measures the driving current of the motor driver and outputs a measure signal corresponding to a result of the measure, and a current/pulse converter circuit that converts the measure signal into a pulse and outputs the pulse,
the MCU comprises:
an rotation speed/duty converter circuit that sets a duty of the first digital signal at a value correlated with a rotation speed of the motor and outputs a duty command signal indicating the set duty, the rotation speed being specified by the rotation command;
a current measuring circuit that measures the driving current of the motor driver and outputs the measure signal corresponding to the result of the measure;
a lead angle adjusting circuit that outputs a lead angle command signal based on the measure signal or a commanded rotation speed;
a lead angle/frequency converter circuit that sets a frequency of the first digital signal at a value correlated with a lead angle of the driving control signal based on a lead angle specified by the lead angle command signal and outputs a frequency command signal indicating the set frequency; and
a pulse generator that generates and outputs the first digital signal based on the duty command signal and the frequency command signal, and
the lead angle adjusting circuit changes the lead angle by varying the lead angle command signal and obtains a lead angle having a minimum current amplitude in a range of variations of the lead angle.

14. The motor driving system according to claim 12, further comprising a temperature sensor that measures a temperature of the motor and outputs a measure signal corresponding to the measured temperature,
the MCU comprising:
a rotation speed/duty converter circuit that sets a duty of the first digital signal at a value correlated with a rotation speed of the motor and outputs a duty command signal indicating the set duty, the rotation speed being specified by the rotation command;
a temperature/frequency converter circuit that sets, based on the measure signal, a frequency of the first digital signal at a value correlated with the measured temperature and outputs a frequency command signal indicating the set frequency; and
a pulse generator that generates and outputs the first digital signal based on the duty command signal and the frequency command signal.

15. The motor driving system according to claim 14, wherein the motor driving circuit comprises
a temperature/motor parameter converter circuit that obtains, based on the frequency information signal, the temperature measured by the temperature sensor and outputs a motor parameter information signal containing information on a motor parameter corresponding to the measured temperature; and
a motor driving waveform control circuit that generates a driving control signal as a PWM signal for driving the motor at a commanded rotation speed, based on the rotation speed information signal and the motor parameter information signal.

16. The motor driving system according to claim 15, wherein the motor parameter is one of a winding resistance, a reactance, and an induced voltage of the motor.

17. The motor driving system according to claim 12, further comprising a resonance sensor that measures a resonance of the motor and outputs a measure signal corresponding to a level of the measured resonance,
wherein the MCU comprising
a rotation speed/duty converter circuit that sets the duty of the first digital signal at a value correlated with the rotation speed of the motor, the rotation speed being specified by the rotation command, and outputs a duty command signal that indicates the set duty;
a minimum-resonance PWM frequency search circuit that outputs a PWM frequency command signal that indicates the PWM frequency of the driving control signal, based on the rotation speed of the motor and the measure signal, the rotation speed being specified by the rotation command;
a frequency converter circuit that sets, based on the PWM frequency command signal, the frequency of the first digital signal at a value correlated with the indicated PWM frequency and outputs a frequency command signal that indicates the set frequency; and
a pulse generator that generates and outputs the first digital signal based on the duty command signal and the frequency command signal,
wherein the minimum-resonance PWM frequency search circuit obtains a PWM frequency where the motor has minimum resonance in the range of variations of the PWM frequency by changing the PWM frequency command signal to vary the PWM frequency.

18. The motor driving system according to claim 12, further comprising a resonance sensor that measures a resonance of the motor and outputs a measure signal corresponding to a level of the measured resonance,
wherein the MCU comprising
a rotation speed/duty converter circuit that sets the duty of the first digital signal at a value correlated with the rotation speed of the motor, the rotation speed being specified by the rotation command, and outputs a duty command signal that indicates the set duty;
a resonance/frequency converter circuit that sets the frequency of the first digital signal at a value correlated with the level of the measured resonance and outputs a frequency command signal that indicates the set frequency; and
a pulse generator that generates and outputs the first digital signal based on the duty command signal and the frequency command signal,
wherein the motor driving circuit comprising
a minimum-resonance PWM frequency search circuit that obtains the resonance level of the motor based on the frequency information signal and outputs a PWM frequency command signal that indicates the PWM frequency of the driving control signal based on the level of the obtained resonance; and
a motor driving waveform control circuit that generates a driving control signal as a PWM signal for driving the motor at a commanded rotation speed, based on the rotation speed information signal and the PWM frequency command signal,
wherein the minimum-resonance PWM frequency search circuit obtains a PWM frequency where the motor has minimum resonance in the range of variations of the PWM frequency by changing the PWM frequency command signal to vary the PWM frequency.

19. The motor driving system according to claim 12, wherein the motor is a three-phase motor.

20. The motor driving system according to claim 12, wherein the motor driving system is applied for driving fans or compressors used for air conditioners or refrigerators.
